(19) United States
(12) Patent Application Publication
(10) Pub. No.: US 2026/0259584 A1
(43) Pub. Date: Sep. 3, 2026

(54) Electronic Device

(71) Applicant: BEIJING 7INVENSUN TECHNOLOGY CO., LTD., Beijing (CN)

(72) Inventors: Junsheng LI, Beijing (CN); Tongbing HUANG, Beijing (CN)

(73) Assignee: BEIJING 7INVENSUN TECHNOLOGY CO., LTD., Beijing (CN)

(21) Appl. No.: 18/995,719

(22) PCT Filed: Aug. 21, 2023
(86) PCT No.: PCT/CN2023/114070

§ 371 Date: Jan. 16, 2025

(30) Foreign Application Priority Data
Aug. 22, 2022 (CN) 202211007084.2

(51) Int. Cl. G06F 1/16; G06F 3/01

(52) U.S. Cl. CPC G06F 1/1686; G06F 3/013

(57) ABSTRACT

An electronic device is provided. The electronic device includes a display screen, a host an image collection device, and a light source. The image collection device is disposed in the host, the light source and a light-transmitting area are disposed on the host, the light-transmitting area is overlapped with a projection of a collection range, on the host, of the image collection device, the image collection device is configured to collect an image of an eye of a user using the electronic device through the light-transmitting area, and the image of the eye includes a facula formed by the light source.

### CROSS-REFERENCE TO RELATED APPLICATIONS

The present disclosure is a national stage application of International Patent Application No. PCT/CN2023/114070, which is filed on Aug. 21, 2023, and claims priority to Chinese Patent Application No. 202211007084.2, filed on Aug. 22, 2022 and entitled “Electronic Device”, the contents of which are hereby incorporated by reference in its entirety.

### TECHNICAL FIELD

The present disclosure relates to the technical field of electronic devices, in particular to an electronic device.

### BACKGROUND

Eyeball tracking generally relates to tracking for movement of the eyeball by measuring the location of a fixation point of the eye or movement of the eyeball relative to the head. By disposing an eyeball tracking module in an electronic device, the movement and fixation direction of eye when a user looks at a specific target can be tracked, which is conducive to interaction between the user and the electronic device.

An eyeball tracking technology can be realized by an optical recording method. The principle of the optical recording method is that movement of the eye of a tested person is recorded by using an infrared camera, namely, an image of the eye which can reflect movement of the eye is acquired, and features of the eye are extracted from the obtained image of the eye to establish an estimation model of sight. The features of the eyes includes: pupil location, pupil shape, iris location, iris shape, eyelid location, canthus location, facula location (or purkinje image), and the like. The optical recording method includes a pupil-cornea reflection method. The principle of the pupil-cornea reflection method is that a near-infrared light source irradiates the eye, the infrared camera shoots the eye, and meanwhile, a reflection point, on the cornea, of the light source, namely, a facula is shot, so that an image of the eye with facula is acquired.

In the art known to inventors, that disposing an eyeball tracking module in an electronic device is realized by disposing an eyeball tracking module on a display screen of the electronic device.

However, by disposing the eyeball tracking module on the display screen of the electronic device to realize eyeball tracking, the thickness of the display screen is increased, further, the thickness of the electronic device is increased, and then the portability of the electronic device and experience of the user are reduced.

### SUMMARY

Some embodiments of the present disclosure provide an electronic device, through an image collection device disposed inside a host as well as a light source and a light-transmitting area which are disposed on the host, the eyeball tracking function of the electronic device is realized under the premise of not increasing the thickness of a display screen of the electronic device.

In a first aspect, some embodiments of the present disclosure provide an electronic device, which includes a display screen and a host, an image collection device and a light source, wherein the image collection device is disposed in the host, the light source and a light-transmitting area are disposed on the host, the light-transmitting area is overlapped with a projection of a collection range, on the host, of the image collection device, the image collection device is configured to collect an image of an eye of a user using the electronic device through the light-transmitting area, and the image of the eye includes a facula formed by the light source.

In some embodiments, a number of the light source is at least two, two sides of the image collection device are provided with at least one light source, and a light-emitting center of the light source and a focus of a lens of the image collection device are disposed on a same straight line.

In some embodiments, the electronic device includes a transparent cover plate or a light filter, wherein the transparent cover plate or the light filter is disposed on the light-transmitting area.

In some embodiments, the image collection device and the host are fixedly mounted at a set angle.

In some embodiments, the image collection device is disposed towards a plane where a keyboard area on the host is located, and the image collection device directly collects the image of the eye through the light-transmitting area.

In some embodiments, the electronic device includes a reflection apparatus, wherein the reflection apparatus is disposed in the host, the image collection device faces the reflection apparatus, and the reflection apparatus is disposed to reflect light rays reflected by the eye of the user.

In some embodiments, the reflection apparatus includes one or more of the following:
a mirror face, a prism and a dichroic mirror.

In some embodiments, the image collection device is movably mounted in the host.

In some embodiments, the electronic device further includes a motor.

The motor is disposed in the host, wherein the motor is connected with the image collection device, and the motor is disposed to adjust the collection range of the image collection device.

In some embodiments, the electronic device further includes a device angle measuring apparatus.

The device angle measuring apparatus is connected with the image collection device, wherein the device angle measuring apparatus is disposed to collect a device angle parameter of the image collection device, and the device angle measuring apparatus is further disposed to transmit the device angle parameter to a processor, so that the processor carries out calibration point correction based on the device angle parameter.

In some embodiments, an elevation angle of the image collection device is determined based on one or more of the following.

Head location of the user; and an adjusting parameter of the display screen, and the adjusting parameter is determined based on a current screen angle parameter of the display screen.

In some embodiments, the electronic device comprises a second rotating shaft and a screen angle measuring apparatus, one end of the display screen is connected with one end of the host through the second rotating shaft, the screen angle measuring apparatus is disposed in the second rotating shaft, the screen angle measuring apparatus is disposed to measure a screen angle parameter of the display screen and transmit the screen angle parameter to a processor, so that the processor carries out calibration point correction based on the screen angle parameter.

Some embodiments of the present disclosure provide an electronic device. The electronic device includes a display screen and a host, an image collection device is disposed in the host, a light source and a light-transmitting area are disposed on the host, the light-transmitting area is overlapped with a projection of a collection range, on the host, of the image collection device, the image collection device is configured to collect an image of the eye of a user using the electronic device through the light-transmitting area, and the image of the eye includes a facula formed by the light source. For the above technical solution, through the image collection device disposed inside the host as well as the light source and the light-transmitting area which are disposed on the host, the eyeball tracking function of the electronic device is realized under the premise of not increasing the thickness of a display screen of the electronic device.

It should be understood that the content described in this part is not intended to identify key or critical features of the embodiments of the present disclosure, nor is it intended to limit the scope of the present disclosure. Other features of the present disclosure will become apparent from the following specification.

### BRIEF DESCRIPTION OF THE DRAWINGS

In order to describe the technical solutions in the embodiments of the present disclosure more clearly, the drawings required to be used in descriptions about the embodiments will be simply introduced below, obviously, the drawings described below are only some embodiments of the present disclosure, and other drawings may further be obtained by those of ordinary skill in the art according to the drawings without creative work.

FIG. 1 illustrates a schematic structure diagram of an electronic device provided by the present disclosure.

FIG. 2a illustrates a schematic structure diagram of an electronic device with an enlarged identifier A provided by the present disclosure.

FIG. 2b illustrates an enlarged partial diagram of an image collection device and a light-transmitting area in part A from the angle of view shown in FIG. 2a provided by the present disclosure.

FIG. 3a illustrates a schematic structure diagram of another electronic device with an enlarged identifier B provided by the present disclosure.

FIG. 3 b illustrates an enlarged partial diagram in part B of another electronic device from the angle of view shown in FIG. 3a provided by the present disclosure.

FIG. 4 illustrates a schematic structure diagram of still another electronic device provided by the present disclosure.

FIG. 5a illustrates a schematic structure diagram of still another electronic device with an enlarged identifier C provided by the present disclosure.

FIG. 5b illustrates an enlarged partial diagram of an image collection device, a light-transmitting area, a motor, a first rotating shaft and a device angle measuring apparatus in part C from the angle of view shown in FIG. 5a provided by the present disclosure.

FIG. 6a illustrates a schematic diagram of a location of a fixation point of a user provided by the present disclosure.

FIG. 6b illustrates a schematic diagram of calibration point correction of an electronic device when head location of a user changes while a screen angle parameter of a display screen does not change provided by the present disclosure.

FIG. 7a illustrates a schematic diagram before location of a display screen changes provided by the present disclosure.

FIG. 7b illustrates a schematic diagram of calibration point correction of an electronic device when head location of a user does not change while a screen angle parameter of a display screen changes provided by the present disclosure.

### DETAILED DESCRIPTION OF THE EMBODIMENTS

The present disclosure is elaborated in detail below with reference to the drawings and embodiments. It can be understood that the specific embodiments described herein are for the purpose of illustrating the present disclosure, rather than limiting the present disclosure. In addition, it is further to be noted that, for ease of description, the drawings only illustrate part, rather than all structures related to the present disclosure.

The embodiments in the present disclosure and features in the embodiments below may be combined with each other without conflict. As used herein, the term “include” and its variants are open-ended, that is, “including, but not limited to”. The term “based on” is “based at least in part on.” The term “one embodiment” means “at least one embodiment”.

It is to be noted that the concepts of “first”, “second”, and the like referred to in the present disclosure are only used to distinguish corresponding contents, but not to limit sequence or interdependencies.

It is to be noted that the modifications to “one” or “a plurality of” in the present disclosure are illustrative and not restrictive, and those skilled in the art should understood that they should be understood as “one or a plurality of”, unless otherwise definitely specified in the context.

In the description of the present disclosure, it is to be noted that orientation or position relationships indicated by terms “central”, “upper”, “lower”, “left”, “right”, “front”, “back” and the like are orientation or position relationships shown in the drawings. For example, “upper” and “lower” are set along the directions of header and footer of the front of paper; “left” and “right” are set in a direction facing the front of paper, and “front” is a direction perpendicular to the front of paper and from the back of paper to front of paper; and “back” is a direction perpendicular to the front of paper and from the front of paper to the back of paper. This setting is not to indicate that indicated devices or components must be in specific orientations but only to conveniently describe the present disclosure and thus should not be understood as limits to the present disclosure. In addition, the technical features or technical solutions involved in different implementation modes of the present disclosure described below may be combined with each other as long as they do not conflict with each other.

### Embodiment

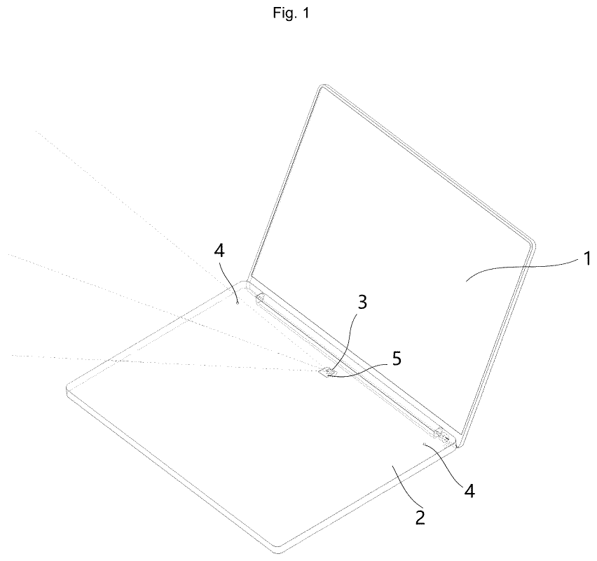

FIG. 1 is a schematic structure diagram of an electronic device provided by the present disclosure, as shown in FIG. 1, some embodiments of the present disclosure provide an electronic device, which includes a display screen 1 and a host 2.

An image collection device 3 is disposed in the host 2, a light source 4 and a light-transmitting area 5 are disposed on the host 2, the light-transmitting area 5 is overlapped with a projection of a collection range, on the host 2, of the image collection device 3, the image collection device 3 is configured to collect an image of the eye of a user using the electronic device through the light-transmitting area 5, and the image of the eye includes a facula formed by the light source 4.

According to the present disclosure, by disposing the image collection device 3 inside the host 2 and disposing the light source 4 and the light-transmitting area 5 on the host 2, the image collection device 3 collects the image of the eye of the user using the electronic device through the light-transmitting area 5, and the eyeball tracking function of the electronic device is realized under the premise of not increasing the thickness of the electronic device.

In the embodiment, the electronic device is a laptop computer as an example, and the electronic device here is not limited to a laptop computer, but may be any electronic device that requires eyeball tracking.

The display screen 1 includes a shell, and a screen which is disposed on the shell and disposed as display.

The host 2 includes a shell, and a keyboard also is disposed on the shell.

The display screen 1 is connected with the host 2 through a second rotating shaft, the second rotating shaft refers to a rotating shaft connecting the display screen 1 and the host 2, the electronic device, through the second rotating shaft, enables relative positions of the display screen 1 and the host 2 to have different included angles, and the relative positions of the display screen 1 and the host 2 may be adjusted according to actual requirements.

The type of the image collection device 3 is not limited herein, only if the image of the eye may be obtained, exemplarily, the image collection device 3 includes but is not limited to: an infrared shooting device, an infrared image sensor, a camera or a vidicon.

The setting mode of the image collection device 3 in the host 2 is not limited, only if the image collection device 3 is disposed inside the host 2. For example, the image collection device 3 is fixedly disposed in the host 2; for another example, the image collection device 3 is movably disposed in the host 2 through a sliding rail, when the position of the user relative to the electronic device changes, the image collection device 3 is adjusted to slide left and right in the sliding rail to ensure that the image collection device 3 still collects the image of the eye of the user when the position of the user relative to the electronic device changes; and still for another example, the image collection device 3 is movably disposed in the host 2, the image collection device 3 is controlled to rotate through the motor, and then the range, for collecting the image of the eye of the user, of the image collection device 3 is adjusted.

The setting position of the image collection device 3 in the host 2 is not limited, only if the image collection device 3 can collect the image of the eye of the user when the user uses the electronic device. The image of the eye is considered as the image including the eye of the user.

In an embodiment, the image collection device 3 is disposed in the host 2, the image collection device 3 is located between the second rotating shaft and the keyboard, at a position with a set distance away from the central position of the second rotating shaft, and the central position of the second rotating shaft is the position where the midpoint of the second rotating shaft is located. The set distance is not limited herein, specifically determined according to the size of the electronic device.

The light source 4 is disposed on the host 2, so that light emitted by the light source 4 may be reflected by the eye of the user to the electronic device, and then a facula is formed in the image of the eye collected by the image collection device 3. Specifically, when the light source 4 irradiates the eye of the user, the image collection device 3 shoots the eye, and correspondingly shoots a reflection point, on the cornea, of the light source 4, namely, a facula, also called the purkinje image, and then the image of the eye with the facula is formed.

The wavelength of the light source 4 is not limited, only if the image collection device 3 collects the image of the eye of the user with a facula.

Exemplarily, the light source 4 is infrared light located in a safe band of the human eye, relative to light of other bands, when infrared light in the safe band of the human eye irradiates the eye, it is greatly absorbed by the water body in the lens of the human eye, and thus the intensity of the light when reaching the retina is greatly reduced.

The arrangement of the light source 4 disposed on the host 2 is not limited, as long as a facula exists in the image of the eye, such as in a predetermined arrangement mode, for example, a horizontal line shape, a square shape and a round shape.

The number of the light source 4 is not limited, and the setting position of the light source 4 on the host 2 is not limited, only if the image collection device 3 can collect the image of the eye with a facula.

In an embodiment, at least one light source 4 is available. Different light sources 4 are disposed at different positions of the host 2, only if the image of the eye includes a facula.

In an embodiment, two light sources 4 are available, the light sources 4 are respectively disposed at positions, close to the second rotating shaft, of the host 2, the two light sources 4 are respectively disposed at left and right ends of the image collection device 3, for example, the two light sources 4 and the image collection device 3 are located on the same straight line, and the image collection device 3 is the midpoint of the two light sources 4, as shown in FIG. 1.

The setting position of the light-transmitting area 5 on the host 2 is not limited, only if the image collection device 3 can collect the image of the eye of the user using the electronic device through the light-transmitting area 5. For example, the light-transmitting area 5 is located above the image collection device 3, the light-transmitting area 5 is disposed in a plane parallel to the host 2, or the light-transmitting area 5 has a certain angle with the plane parallel to the host 2, specifically determined according to the shotting range of the image collection device 3, only if it is guaranteed that the position of the light-transmitting area 5 covers the shooting range of the image collection device 3 finally.

The light-transmitting area 5 is overlapped with a projection of a collection range, on the host 2, of the image collection device 3 is understood as that the light-transmitting area 5 is located in the collection range of the image processing device 3, covering the shooting range of the whole angle of view from the image collection device 3 to the human eye. After light emitted by the light source 4 is reflected by the eye of the user, the light reflected by the eye of the user first passes through the light-transmitting area 5 and then is collected by the image collection device 3.

Through the light-transmitting area 5, all light reflected by the eye of the user can transmit, or only light, corresponding to the band of the light source 4, reflected by the eye of the user can transmit, it can be set according to actual requirements specifically.

According to the present disclosure, by disposing the image collection device 3 inside the host 2 and disposing the light source 4 and the light-transmitting area 5 on the host 2, the image collection device 3 can collect the image of the eye of the user using the electronic device through the light-transmitting area 5, and the eyeball tracking function of the electronic device is realized. In addition, by disposing the image collection device 3 inside the host 2, the eyeball tracking function of the electronic device can be realized without increasing the thickness of a display screen of the electronic device.

In an embodiment, the number of the light source 4 is at least two, two sides of the image collection device 3 are provided with at least one light source 4, and the light-emitting center of the light source 4 and the focus of a lens of the image collection device 3 are disposed on the same straight line.

That the number of the light source 4 is at least two, andtwo sides of the image collection device 3 are provided with at least one light source is understood as that at least one light source 4 is distributed on each of two sides of the image collection device 3, so that the light-emitting center of the light source 4 and the focus of a lens of the image collection device 3 are disposed on the same straight line.

In an embodiment, the number of the light source 4 is six, and the light sources 4 are distributed in an area, between the second rotating shaft and the keyboard, on the host 2, and distributed around the image collection device 3.

In an embodiment, the number of the light source 4 is six, with three light sources 4 distributed on each of two sides of the image collection device 3, and the three light sources 4 are distributed in a horizontal line shape on each side of the image collection device 3.

In an embodiment, the number of the light source 4 is three, one light source 4 is distributed on each of two sides of the image collection device 3, the other light source 4 is distributed at any position of the keyboard, and the position of the light source 4 on the keyboard is adjusted according to actual requirements, only if it is ensured that light emitted by the three light sources 4 is received by the image collection device 3 after being reflected by the eye of the user.

When a plurality of light sources 4 are available, the light-emitting center is the geometric center point of the array.

The focus of the lens of the image collection device 3 refers to a convergence point of parallel light rays after being refracted by the lens of the image collection device 3. When one lens of the image collection device 3 is available, the focus of the lens of the image collection device 3 is the focus of the lens; and when the lens of the image collection device 3 is a lens group formed by a plurality of lens, the focus of the lens of the image collection device 3 is the focus of the lens group.

By disposing the light-emitting center of the light source 4 and the focus of the lens of the image collection device 3 on the same straight line, it ensures that light emitted by the light source 4 is received by the image collection device 3 after being reflected by the eye of the user.

In an embodiment, the light-emitting center of the light source 4 and the focus of the lens of the image collection device 3 is not on the same straight line, only if it is ensured that light emitted by the light source 4 can be received by the image collection device 3 after being reflected by the eye of the user, specifically, the position of the light-emitting center of the light source is set according to actual requirements.

In an embodiment, a transparent cover plate or a light filter is disposed on the light-transmitting area 5.

When the transparent cover plate is disposed on the light-transmitting area 5, the transparent cover plate can cover the shooting range of the whole angle of view from the image collection device 3 to the human eye, and can transmit all light reflected by the eye of the user. Light emitted by the light source 4 is reflected by the eye of the user, and light rays reflected by the eye of the user are emitted to the image collection device 3 through the transparent cover plate, so as to be received by the image collection device 3. By disposing the transparent cover plate on the light-transmitting area 5, a protection role is played on the image collection device 3 inside the host 2, and meanwhile, the collection range of the image collection device 3 is not blocked.

When the light filter is disposed on the light-transmitting area 5, the light filter refers to an optical device for selecting a desired radiation band. The type of the light filter is not limited, and it is a film light filter, for example.

The light filter is determined according to the band of the light source 4, so that light emitted by the light source 4 can reach the image collection device 3 through the light filter after being reflected by the eye of the user, for example, when the light source 4 is infrared light, light rays reflected by the eye of the user are infrared light rays, through the light filter, only infrared light corresponding to the band of the light source 4 can transmit, while light of other bands cannot pass through the light filter. After light rays reflected by the eye of the user are filtered by the light filter, light rays reaching the image collection device 3 finally only contain light corresponding to the band of the light source 4, so that the image of the eye collected by the image collection device 3 is clearer.

The size of the transparent cover plate or the light filter is not limited, only if the transparent cover plate or the light filter can cover the shooting range of the whole angle of view from the image collection device 3 to the human eye. For example, the transparent cover plate or the light filter is overlapped with the whole light-transmitting area in size; and still for example, the transparent cover plate or the light filter is larger than the light-transmitting area in size and covers the whole light-transmitting area.

In the present disclosure, by disposing the transparent cover plate on the light-transmitting area 5, protection for the image collection device 3 is realized; and by disposing the light filter on the light-transmitting area 5, the precision of the image of the eye collected by the image collection device 3 is improved.

In an embodiment, the image collection device 3 and the host 2 are fixedly mounted at a set angle.

The set angle refers to a set included angle between the image collection device 3 and a plane where the host 2 is located, the set angle is not limited, different set angles enable the image collection device 3 to correspond different collection ranges, and the set angle is any angle greater than or equal to 0°, only if the image collection device 3 collects the image of the eye of the user.

The fixed mounting mode of the image collection device 3 is not limited, only if the image collection device 3 is fixed in the host 2. For example, the image collection device 3 is fixed in the host 2 in a welding mode, and has a set angle with the host 2; and the image collection device 3 is fixed in the host 2 in a thread connection mode, and has a set angle with the host 2.

By fixedly mounting the image collection device 3 with the host 2 at the set angle without a moving mechanism structure, the image collection device 3 is more reliably fixed in the host 2, meanwhile, when mounting the image collection device 3, by adjusting the set angle, the image collection device 3 has different collection ranges.

In an embodiment, the image collection device 3 is disposed towards a plane where a keyboard area on the host 2 is located, and the image collection device 3 directly collects the image of the eye through the light-transmitting area 5.

That the image collection device 3 is disposed towards a plane where a keyboard area on the host 2 is located is understood as that a projection area, on the host 2, of the shooting range of the image collection device 3 is located in the plane where the keyboard area on the host 2 is located.

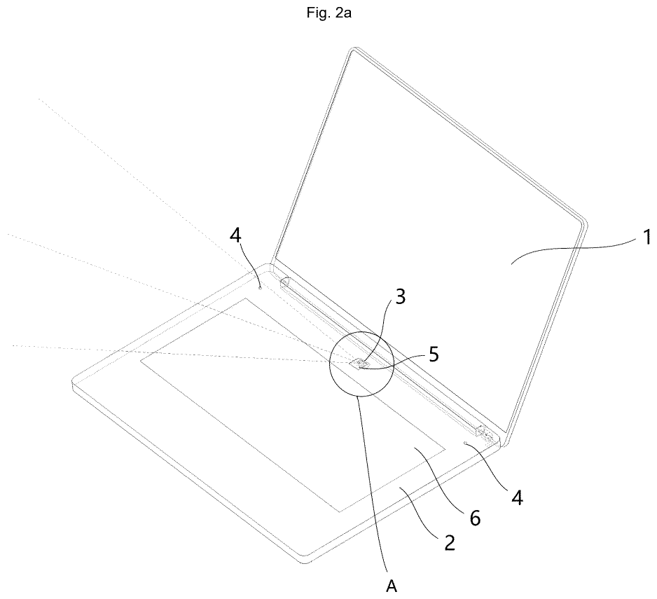

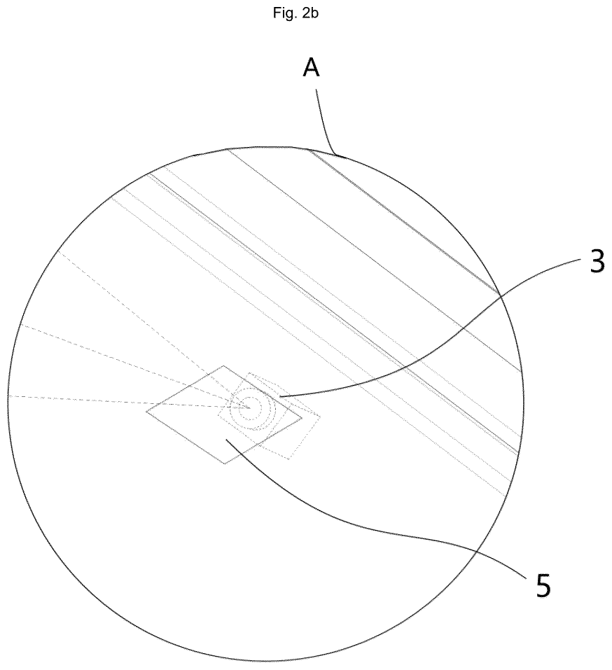

FIG. 2 is an enlarged partial diagram of an image collection device and a light-transmitting area from the angle of view shown in FIG. 1 provided the present disclosure, from FIG. 2, the image collection device 3 is disposed towards the plane where the keyboard area 6 on the host 2 is located, light rays reflected by the eye of the user are collected by the image collection device 3 through the light-transmitting area 5 to form a facula, namely, the image collection device 3 collects the image of the eye through the light-transmitting area 5, and other components do not need to be added, so that inside space of the host 2 is saved.

In an embodiment, a reflection apparatus is disposed in the host 2, the image collection device 3 faces the reflection apparatus, and the reflection apparatus is disposed to reflect light rays reflected by the eye of the user.

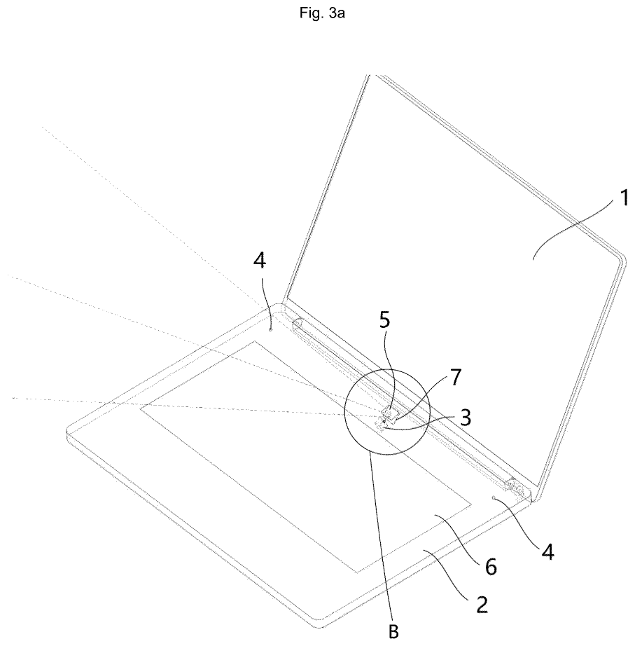

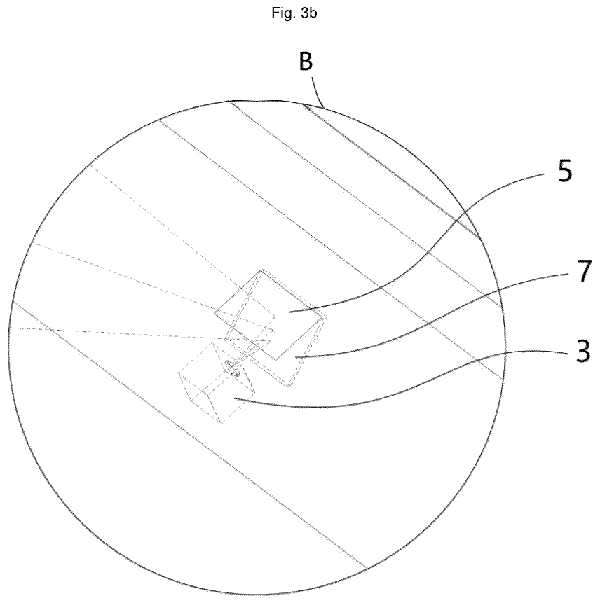

FIG. 3 is a schematic structure diagram of another electronic device provided by the present disclosure, in FIG. 3, a reflection apparatus 7 disposed in the host 2 is shown.

The type of the reflection apparatus 7 is not limited, only if light rays reflected by the eye of the user can be reflected. For example, one or more of the following are included: a mirror face, a prism and a dichroic mirror, disposed to reflect light rays reflected by the eye of the user.

The image collection device 3 faces the reflection apparatus 7, and the reflection apparatus 7 is disposed to reflect light rays reflected by the eye of the user is understood as that light emitted by the light source 4 reaches the reflection apparatus 7 through the light-transmitting area 5 after being reflected by the eye of the user, and the reflection apparatus 7 reflects the light rays reflected by the eye of the user, which are collected by the image collection device 3.

The setting position of the reflection apparatus 7 inside the host 2 is not limited, only if the reflection apparatus 7 reflects light rays reflected by the eye of the user when the image collection device 3 collects the image of the eye of the user. For example, the reflection apparatus 7 is disposed inside the host 2, the reflection apparatus 7 is located in the collection range of the image collection apparatus 3 and has a certain included angle with the plane where the host 2 is located, by changing the included angle between the reflection apparatus 7 and the plane where the host 2 is located, a light path reflecting light rays reflected by the eye of the user changes, and thus the collection range of the image collection device 3 is adjusted.

The light-transmitting area 5 and the reflection apparatus 7 correspond to the light source 4, so that light emitted by the light source 4 reaches the reflection apparatus 7 through the light-transmitting area 5 after being reflected by the eye of the user.

In an embodiment, the light source 4 is infrared light, a light filter is disposed on the light-transmitting area 5, the light filter is an infrared light filter, and the reflection apparatus 7 is a dichroic mirror. After light reflected by the eye of the user is filtered by the infrared light filter, only infrared light of the corresponding band of the light source 4 reaches the reflection apparatus 7, through the reflection apparatus 7, infrared light of the corresponding band of the light source 4 almost completely transmits, but light of other wavelengths is almost completely reflected, and the reflection apparatus 7 reflects light reflected by the eye of the user, which is finally collected by the image collection device 3. Therefore, after light reflected by the eye of the user passes through the infrared light filter and the dichroic mirror, finally, only infrared light of the corresponding band of the light source 4 can be collected by the image collection device 3, so that the image of the eye collected by the image collection device 3 is clearer.

In the present disclosure, the reflection apparatus 7 is disposed in the host 2 to reflect light rays reflected by the eye of the user, a light path for reflecting light rays reflected by the eye of the user is changed by changing the position of the reflection apparatus 7 in the host 2 or the included angle between the reflection apparatus 7 and the plane where the host 2 is located, so that the collection range of the image collection device 3 is more flexible.

In an embodiment, the reflection apparatus 7 includes one or more of the following:
a mirror face, a prism and a dichroic mirror.

When parallel incident light rays are emitted to the mirror face, they will still be reflected in a direction in parallel. The type of the prism is not limited, only if it can be configured to reflect light rays reflected by the eye of the user, such as a simple prism, a roof prism or a compound prism, the simple prism refers to a prism with all work faces vertical to a main section, including prisms in the forms of primary reflection, secondary reflection and tertiary reflection; the roof prism refers to a prism with roof faces, and the roof faces are reflection faces vertical to each other; and the compound prism refers to a prism composed of two or more prisms. For the dichroic mirror, during 45° incidence or large-angle incidence, incident light is separated to a specific spectrum, then the direction of a light path of part of the spectrum is changed, and it is characterized in that almost all light of a certain wavelength transmit and almost light of other wavelengths is almost completely reflected. The type of the dichroic mirror is not limited, for example, it is a single-band-pass dichroic mirror or a multi-band-pass dichroic mirror.

By selecting different reflection apparatuses 7, light rays reflected by the eye of the user have different properties after being reflected by the reflection apparatus 7.

The image collection device 3 in the present disclosure is movably disposed in the host 2.

In an embodiment, the image collection device 3 is movably mounted in the host 2.

The movable mounting mode of the image collection device 3 in the host 2 is not limited, only if the image collection device 3 is movably mounted in the host 2. For example, the image collection device 3 is movably mounted in the host 2 by a base, the base is fixed in the host 2, the image collection device 3 is connected with the base by a rotating shaft, the image collection device 3 rotates on the base through the rotating shaft, and then the range that the image collection device 3 collects the image of the eye of the user is adjusted.

In an embodiment, the electronic device further includes a motor 8.

The motor 8 is disposed in the host 2, the motor 8 is connected with the image collection device 3, and the motor 8 is disposed to adjust the collection range of the image collection device 3.

The motor 8 refers to an electromagnetic apparatus that realizes electric energy conversion or transmission according to the law of electromagnetic induction.

The setting position of the motor 8 in the host 2 is not limited, only if the motor 8 can control the image collection device 3 to rotate. For example, the motor 8 is disposed in an area, close to the second rotating shaft, in the host 2, specifically, the setting position of the motor 8 is determined according to the setting position of the image collection device 3 in the host 2.

The setting mode of the motor 8 in the host 2 is not limited, only if the motor 8 is disposed in the host 2. For example, the motor 8 is fixedly disposed or movably disposed in the host 2.

The type of the motor 8 is not limited in the present disclosure, only if the image collection device 3 is controlled to rotate. For example, it is a direct-current motor, asynchronous motor or synchronous motor.

The connecting mode of the motor 8 and the image collection device 3 is not limited, for example, the motor 8 is connected with the image collection device 3 by a first rotating shaft.

In an embodiment, the image collection device 3 is fixed on the host 2, the motor 8 is also fixed on the host 2, and the motor 8 and the image collection device 3 are movably connected.

In an embodiment, the image collection device 3 is fixedly connected with the motor 8, and then is movably connected with the host 2.

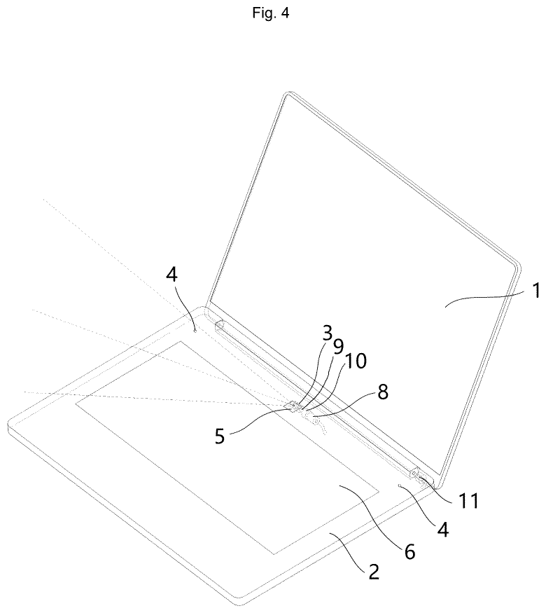

FIG. 4 is a schematic structure diagram of still another electronic device provided by the present disclosure, FIG. 4 illustrates that an image collection device 3 is movably mounted in a host 2 through a motor 8, and the motor 8 is connected with the image collection device 3 through a first rotating shaft 9.

The first rotating shaft 9 refers to a shaft linking the motor 8 and the image collection device 3 and configured to bear both bending moment and torque during rotation work.

In the present disclosure, the first rotating shaft 9 is not limited, only if the motor 8 controls the image collection device to rotate through the first rotating shaft 9. For example, the first rotating shaft 9 is a horizontal-line-shaped rotating shaft.

The motor 8 is connected with the image collection device 3 by the first rotating shaft 9, and is configured to control the image collection device 3 to rotate, and by controlling the image collection device 3 to rotate through the motor 8, the collection range of the image collection device 3 is adjusted.

In an embodiment, the electronic device further includes a device angle measuring apparatus 10.

The device angle measuring apparatus 10 is connected with the image collection device 3, the device angle measuring apparatus 10 is configured to collect a device angle parameter of the image collection device 3, and the device angle measuring apparatus 10 is further disposed to transmit the device angle parameter to a processor, so that the processor can carry out calibration point correction based on the device angle parameter.

The device angle measuring apparatus 10 refers to an apparatus configured to measure an angle of a device, and is configured to collect the device angle parameter of the image collection device 3.

The device angle parameter is a parameter for representing the angle or angle change of the image collection device 3. The device angle parameter of the image collection device 3 includes but is not limited to a first parameter before the image collection device 3 is rotated through the motor 8, a second parameter after the image collection device 3 is rotated through the motor 8, a third parameter of angle change that the image collection device 3 is rotated through the motor 8 and a set angle parameter of the image collection device 3, the set angle parameter refers to an angle parameter set according to actual requirements of the image collection device 3, and it is configured as that the rotating angle of the image collection device 3, such as the third parameter, is measured according to the set angle parameter and the second parameter after the image collection device 3 is rotated through the motor 8. The rotating angle of the image collection device 3 is obtained through the device angle measuring apparatus 10, so that the shooting range of the image collection device 3 is controlled.

The first parameter, the second parameter and the third parameter is parameters related to an angle, the angle is an angle of the image collection device 3 relative to a reference object, and the reference object is not limited and is set according to an actual situation. The reference object is a host 2. The set angle parameter is an initial angle of the image collection device 3 and the host 2.

The type of the device angle measuring apparatus 10 is not limited, only if the rotating angle of the image collection device 3 following the motor 8 is measured. For example, the device angle measuring apparatus 10 is an angle sensor, a shaft capable of rotating is disposed in the angle sensor, when the shaft rotates, the angle sensor counts according to the rotating of the shaft, the counting increases when rotation is carried out in one direction, and the counting decreases when the rotation direction changes. For another example, the device angle measuring apparatus 10 is a motor 8, as the image collection device 3 is controlled by the motor 8, the angle parameter of the image collection device 3 relative to the motor 8 is known. The motor 8 can determine the angle parameter of the image collection device 3.

The connecting mode of the device angle measuring apparatus 10 and the image collection device 3 is not limited, only if the angle measuring apparatus 10 measures the rotating angle of the image collection device 3 following the motor 8. For example, the device angle measuring apparatus 10 is connected with the image collection device 3 and the motor 8 through the first rotating shaft 9, when the motor 8 rotates, the first rotating shaft 9 is driven to rotate, the rotating shaft 9 may drive the image collection device 3 to rotate, and then when the first rotating shaft 9 rotates, the device angle measuring apparatus 10 determines the device angle parameter of the image collection device 3 according to rotation of the first rotating shaft 9.

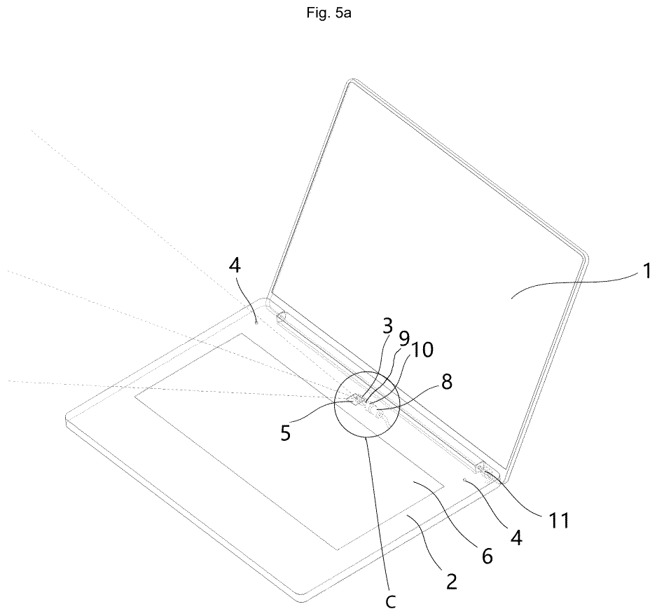

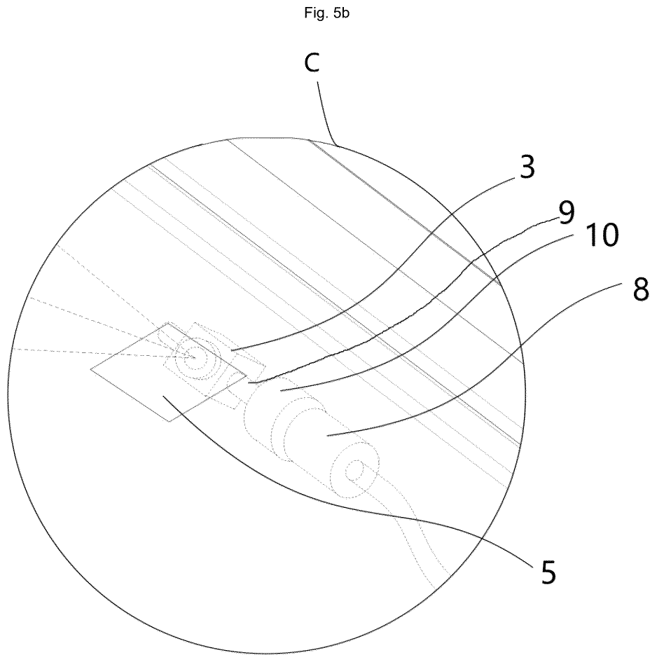

FIG. 5 is an enlarged partial diagram of an image collection device, a light-transmitting area, a motor, a first rotating shaft and a device angle measuring apparatus from the angle of view shown in FIG. 4 provided by the present disclosure, from FIG. 5, it can be known that the image collection device 3 is movably mounted in a host 2 through a motor 8, and the motor 8 is connected with the image collection device 3 through the first rotating shaft 9. The device angle measuring apparatus 10 is connected with the image collection device 3, and collects the device angle parameter of the image collection device 3. When the motor 8 rotates, the motor 8 drives the first rotating shaft 9 to rotate, the first rotating shaft 9 drives the image collection device 3 to rotate, and then the device angle measuring apparatus 10 determines the device angle parameter of the image collection device 3 according to rotation of the first rotating shaft 9.

The device angle measuring apparatus 10 is further disposed to transmit the device angle parameter to a processor, so that the processor can carry out calibration point correction based on the device angle parameter.

The calibration point is considered as a point displayed on the display screen 1, configured as carrying out sight calibration.

The device angle measuring apparatus 10 transmits the device angle parameter to the processor, so that the processor can acquire the rotating angle of the image collection device 3, namely, the elevation angle of the image collection device 3, and then calibration point correction is carried out through the device angle parameter.

The mode that calibration point correction is carried out through the device angle parameter is not limited, for example, the processor acquires the rotating angle of the image collection device 3 according to the device angle parameter uploaded by the device angle measuring apparatus 10, then angle change of a central optical shaft of the image collection device 3 is acquired, and through angle change of the central optical shaft of the image collection device 3, the calibration point and a fixation point are always kept in one-to-one correspondence relationship before and after direction adjustment of the central optical shaft of the image collection device 3.

Through that the calibration point and the fixation point are always kept in one-to-one correspondence before and after direction adjustment of the central optical shaft of the image collection device 3, that the processor corrects the calibration point based on the device angle parameter is realized.

In an embodiment, the elevation angle of the image collection device 3 is determined based on one or more of the following:
head location of the user; and an adjusting parameter of the display screen 1, and the adjusting parameter is determined based on a current screen angle parameter of the display screen 1.

Head location of the user refers to the location of the head of the user relative to the display screen 1.

The screen angle parameter of the display screen 1 refers to an angle parameter of the display screen 1 relative to the host 2, the screen angle parameter includes but is not limited to a first angle parameter before an angle of the display screen 1 relative to the host 2 changes, a second angle parameter after the angle of the display screen 1 relative to the host 2 changes and a third angle parameter when the angle the display screen 1 relative to the host 2 is a set angle. The set angle may be an angle, of the display screen 1 relative to the host 2, set according to an actual requirement, and the set angel of the corresponding display screen 1 relative to the host 2 is 0 when the electronic device is closed.

The adjusting parameter of the display screen 1 is determined through the screen angle parameter, namely, angle change relative to the host 2 when the display screen 1 is adjusted, or angle change relative to the display screen 1 before adjustment, or angle change relative to the display screen 1 of the set angle.

When the head location of the user changes and the adjusting parameter of the display screen 1 does not change, the elevation angle of the image collection device 3 is synchronously adjusted according to the change of the head location of the user in order to achieve a better collection effect of the image collection device 3 when the elevation angle of the image collection device 3 changes, the processor carries out calibration point correction according to the device angle parameter determined by the elevation angle of the image collection device 3.

When the head location of the user does not change and the adjusting parameter of the display screen 1 changes, the elevation angle of the image collection device 3 is synchronously adjusted according to the adjusting parameter of the display screen 1, so that the image collection device 3 may always ensure collection for the image of the eye of the user in the process that the adjusting parameter of the display screen 1 changes.

When both of the head location of the user and the adjusting parameter of the display screen 1 change, the elevation angle of the image collection device 3 is synchronously adjusted according to the head location of the user and the adjusting parameter of the display screen 1.

The elevation angle of the image collection device 3 is determined through one or more of the head location of the user and the adjusting parameter of the display screen 1, so when the head location of the user and/or the adjusting parameter of the display screen 1 change/changes, the elevation angle of the image collection device 3 is synchronously adjusted, and thus the image collection device 3 can always ensure collection for the image of the eye of the user.

In an embodiment, one end of the display screen 1 is connected with one end of the host 2 through a second rotating shaft, a screen angle measuring apparatus 11 is disposed in the second rotating shaft, the screen angle measuring apparatus 11 is disposed to measure a screen angle parameter of the display screen 1 and transmit the screen angle parameter to the processor, so that the processor can carry out calibration point correction based on the screen angle parameter.

The screen angle measuring apparatus 11 refers to an apparatus configured to measure a relative angle of the display screen 1 and the host 2, and the screen angle parameter of the display screen 1 can be acquired through the screen angle measuring apparatus 11.

The type of the screen angle measuring apparatus 11 is not limited, only if the screen angle parameter of the display screen 1 can be determined, for example, it is an angle sensor. The screen angle measuring apparatus 11 and the device angle measuring apparatus 10 are the same angle measuring apparatus or different angle measuring apparatuses only if the corresponding function of the angle measuring apparatus is realized.

The setting position of the screen angle measuring apparatus 11 in the second rotating shaft is not limited, only if the screen angle parameter of the display screen 1 can be determined. For example, it is that the screen angle measuring apparatus 11 is disposed at the rightmost end of the second rotating shaft; and for another example, the screen angle measuring apparatus 11 is disposed at the leftmost end of the second rotating shaft.

That the screen angle measuring apparatus 11 transmits the screen angle parameter to the processor is that the processor acquires angle change of the display screen 1 relative to the host 2, so that calibration point correction is carried out through the screen angle parameter.

The mode that calibration point correction is carried out through the screen angle parameter it not limited, for example, when the screen angle parameter of the display screen 1 changes, correspondingly, a calibration point 1 on the display screen 1 changes following angle change of the display screen 1, and a fixation point of the user on the display screen 1 also changes. The electronic device determines the rotating angle of the display screen 1 according to the screen angle measuring apparatus 11, then position relationship between the calibration point after change and the fixation point after change is deduced, meanwhile, the calibration point after change is moved to the corresponding position of the fixation point after change, so that the fixation point and the calibration point are always kept in a one-to-one correspondence relationship before and after the angle position of the display screen 1 is adjusted.

Through that the fixation point and the calibration point are always kept in one-to-one correspondence relationship before and after the screen angle parameter is changed, that the processor corrects the calibration point based on the screen angle parameter is realized.

When the head location of the user does not change and the adjusting parameter of the display screen 1 changes, the elevation angle of the image collection device 3 is synchronously adjusted according to the adjusting parameter of the display screen 1, so that the image collection device 3 can always ensure collection for the image of the eye of the user in the process that the adjusting parameter of the display screen 1 changes. The processor carries out calibration point correction according to the device angle parameter determined by the elevation angle of the image collection device 3 and the screen angle parameter of the display screen 1 measured by the screen angle measuring apparatus 11.

When both of the head location of the user and the adjusting parameter of the display screen 1 change, the elevation angle of the image collection device 3 can be adjusted according to the head location of the user and the adjusting parameter of the display screen 1. The processor carries out calibration point correction according to the device angle parameter determined by the elevation angle of the image collection device 3 and the screen angle parameter of the display screen 1 measured by the screen angle measuring apparatus 11.

All the electronic devices in the present disclosure measures the device angle parameter of the image collection device 3 by disposing the device angle measuring apparatus 10 and measure the screen angle parameter of the display screen 1 by disposing the screen angle measuring apparatus, and the processor can carry out calibration point correction according to the device angle parameter and/or the screen angle parameter.

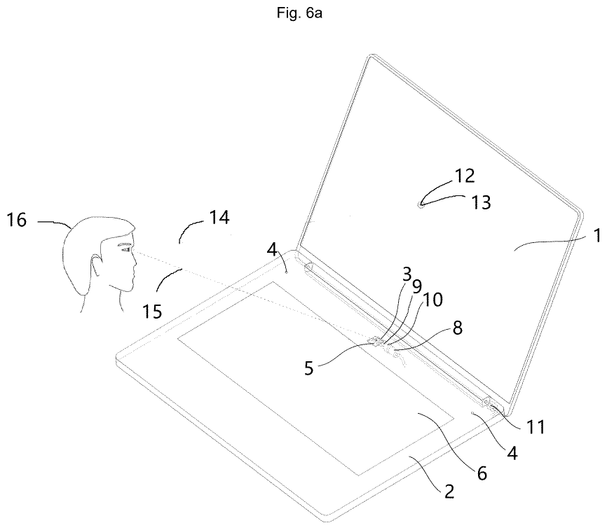

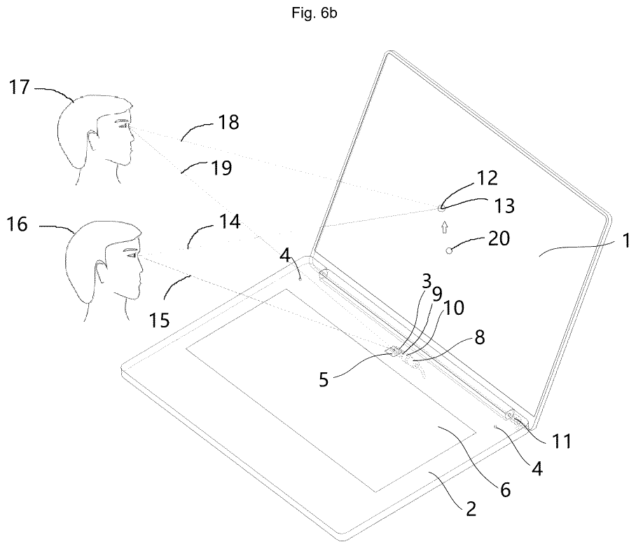

In an embodiment, FIGS. 6a and 6b are schematic diagrams of calibration point correction of an electronic device when head location of a user changes while a screen angle parameter of a display screen 1 does not change, and FIG. 6a is a schematic diagram of a location of a fixation point of a user provided by the present disclosure; and FIG. 6b is a schematic diagram of calibration point correction of an electronic device when head location of a user changes while a screen angle parameter of a display screen does not change provided by the present disclosure.

As shown in FIG. 6a, the head location of the user is the head location 16, the fixation point of the user on the display screen 1 is the fixation point 12, and the calibration point is calibration point 13 and configured to calibrate the location of the fixation point of the user when the user gazes the display screen 1, so that the fixation point 12 and the calibration point 13 are located at the same position on the display screen 1 finally. FIG. 6a further illustrates the central optical shaft 15 of the sight 14 of the user and the image collection device 3. The sight of the user 14 is the path that the sight of the user reaches the display screen 1 from the eye.

As shown in FIG. 6b, when the location of the head of the user moves to the head location 17 from the head location 16, correspondingly, the sight of the user changes to sight 18 from sight 14, and the central optical shaft of the image collection device 3 changes to the central optical shaft 19 from the central optical shaft 15.

Assuming that the head moves, the display screen 1 and a picture displayed by the display screen 1 are fixed, and the fixation point of the sight on the display screen 1 does not change, when head location of the user moves to the head location 17 from head location 16, in order to achieve a better collection effect, the electronic device synchronously adjusts the elevation angle of the image collection device 3 according to the change of head location of the user, namely, the electronic device controls the motor 8 to drive the image collection device 3 to rotate, and the direction of the central optical shaft of the image collection device 3 is adjusted.

When the angle of the image collection device 3 changes, the calibration point will follow the image collection device 3 to deflect, that is, the central optical shaft of the image collection device 3 changes, and the calibration point 13 will deflect to the calibration point 20 following the image collection device 3. The electronic device acquires the rotating angle of the image collection device 3 according to the device angle parameter of the image collection device 3 measured by the device angle measuring apparatus 10, then angle change of the central optical shaft of the image collection device 3 is acquired, location relationship between the calibration point 20 and the fixation pint 12 is deduced, and meanwhile, the calibration point 20 is moved to the fixation point 12, so that the calibration point 20 and the fixation point 12 are always kept in one-to-one correspondence relationship before and after direction adjustment of the central optical shaft of the image collection device 3. Through that the calibration point and the fixation point are always kept in one-to-one correspondence before and after direction adjustment of the central optical shaft of the image collection device 3, that the processor corrects the calibration point based on the device angle parameter is realized.

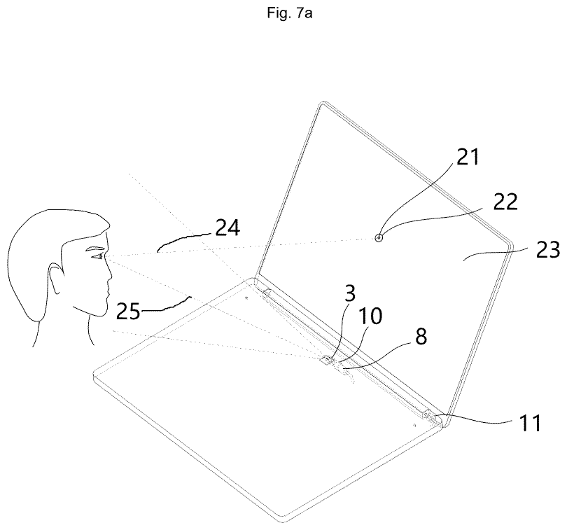

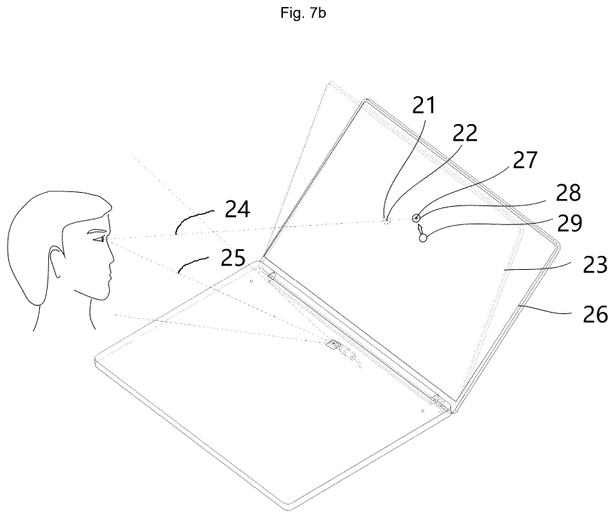

In an embodiment, FIGS. 7a and 7b are schematic diagrams of calibration point correction of an electronic device when head location of a user changes while a screen angle parameter of a display screen does not change, and FIG. 7a is a schematic diagram before location of a display screen changes provided by the present disclosure; and FIG. 7b is a schematic diagram of calibration point correction of an electronic device when head location of a user changes while a screen angle parameter of a display screen does not change provided by the present disclosure.

As shown in FIG. 7a, the location of the display screen before change is location 23, the fixation point of the user on the display screen is fixation point 21, the calibration point is calibration point 22, the sight of the user is 24, and the central optical shaft of the image collection device 3 is 25.

As shown in FIG. 7b, assuming that the head location of the user does not change, the direction of sight is fixed, the sight of the user is 24, the central optical shaft of the image collection device 3 is 25, when the location of the display screen is adjusted to 26 from 23, the calibration point on the display screen is adjusted following the angle of the display screen and is adjusted from calibration point 22 to calibration point 29, and the fixation point of the sight of the user on the screen is changed to fixation point 27 from fixation point 21. The electronic device acquires the adjusting angle of the display screen according to the screen angle parameter of the display screen measured by the screen angle measuring apparatus 11, then position relationship between the calibration point 29 and the fixation point 27 is deduced, meanwhile, the calibration point is moved to calibration point 28 from calibration point 29, so that the fixation point and the calibration point are always kept in a one-to-one correspondence relationship before and after the angle position of the display screen is adjusted. Through that the fixation point and the calibration point are always kept in one-to-one correspondence relationship before and after the screen angle parameter is changed, that the processor corrects the calibration point based on the screen angle parameter is realized.

The following is an exemplary description of the present disclosure.

The electronic device provided by the present disclosure includes a display screen, a host, an eye image camera module (namely, an eye image camera, also named as an image collection device), a reflection apparatus, an eye image camera window (namely, a light-transmitting area), and an infrared lamp (namely, a light source).

The eye image camera is disposed in an inside structure space of the host, and is disposed separately with the screen (namely, the display screen).

The eye picture camera directly captures the image of the eye, or the eye picture camera captures the image of the eye through the reflection apparatus.

The reflection apparatus is a mirror face, or a prism, or a dichroic mirror.

At least one group of infrared lamps is available, which is disposed on the host, and disposed on two sides of the eye image camera. The light-emitting center of the infrared lamp and the focus of a lens of the eye image camera are disposed on the same axis.

The eye image camera and the display screen are mounted at a certain angle, and the reflection apparatus and the eye image camera are mounted at a certain included angle.

The infrared light filter is disposed on a light path between the eye image camera and the human eye.

In an embodiment, the eye image camera is disposed in the host, and the eye image camera and the screen are disposed in a split manner. The eye image camera is disposed in the following four situations.

1. As shown in FIG. 2, the eye image camera is disposed in the host, and is disposed separately with the screen, the eye image camera is independently mounted fixedly, and the eye image camera does not follow adjustment of the screen.

A first angle measuring apparatus (namely, a screen angle measuring apparatus) is disposed on a rotating shaft of the screen (namely, a second rotating shaft), and the first angle measuring apparatus transmits the current screen angle parameter to a processor. The processor corrects the calibration point according to the screen adjusting parameter.

2. As shown in FIG. 3, the eye image camera is disposed in the host, and is disposed separately with the screen, a reflection apparatus and a window (light-transmitting area) are disposed in front of the eye image camera, and the eye image camera and the reflection apparatus are fixedly mounted and do not follow adjustment of the screen.

A first angle measuring apparatus is disposed on a rotating shaft of the screen, and the first angle measuring apparatus transmits the current screen angle parameter to a processor. The processor corrects the calibration point according to the screen adjusting parameter.

3. As shown in FIG. 5, the eye image camera is disposed in the host, and is disposed separately with the screen, the eye image camera is movably mounted, and the eye image camera is relatively synchronously adjusted following the screen, so as to ensure that the relative angle between the eye image camera and the screen is unchanged. Based on that the relative angle between the eye image camera and the screen is unchanged, the position of the calibration point before and after the eye image camera and the screen are adjusted is kept unchanged. If the position of any one of the eye image camera and the screen changes, the position of the calibration point will change. By correcting the position of the calibration point, the calibration point and the fixation point are always in one-to-one correspondence before and after the calibration point and the fixation point are adjusted.

A first angle measuring apparatus is disposed on a rotating shaft of the screen, and the first angle measuring apparatus transmits the current screen angle parameter to a processor. The eye image camera is connected with the motor through a rotating shaft (namely, a first rotating shaft), a second angle measuring apparatus (namely, a device angle measuring apparatus) is disposed at the rotating shaft, and the second angle measuring apparatus transmits the current angle parameter of the eye image camera to the processor. The processor synchronously adjusts the elevation angle of the eye image camera according to the screen adjusting parameter to correct the calibration point.

4. As shown in FIG. 5, the eye image camera is disposed in the host, and is disposed separately with the screen, the eye image camera is movably mounted, and the eye image camera is synchronously adjusted following change of the head location.

A first angle measuring apparatus is disposed on a rotating shaft of the screen, and the first angle measuring apparatus transmits the current screen angle parameter to a processor. The eye image camera is connected with the motor by a rotating shaft, a second angle measuring apparatus is disposed at the rotating shaft, and the second angle measuring apparatus transmits the current angle parameter of the eye image camera to a processor. The processor synchronously adjusts the elevation angle of the eye image camera according to change of the head location of the user to correct the calibration point.

For the electronic device provided by the present disclosure, by disposing the image collection device below the screen, the image collection device and the screen are disposed in a split manner. The setting position of the image collection device is more flexible, the image collection device is mounted in a shell of the host, and space in the shell of the host is relatively large, so that the image collection device can be more easily hidden; and the image collection device is relatively large in size, is disposed separately with the screen, and does not occupy the space of the screen, then the screen may be made lighter and thinner, so that the appearance of the electronic device is more concise and more attractive.

In the present disclosure, when the image collection device is fixedly mounted in the host, the advantage is that as there is no moving mechanism structure, better reliability is realized. That the angle of the display screen is measured and transmitted to the algorithm is disposed as that a fixation point is estimated in a manner of calculating a current intersection point of the sight and the display screen.

In the present disclosure, when the image collection device is movably mounted in the host, the advantage is that larger head movement range is adapted, the collection range of the image collection device is wider, and the flexibility is higher. That the angles of the image collection device and the display screen are measured and transmitted to the algorithm is disposed as that a fixation point is estimated in a manner of calculating a current intersection point of the sight and the display screen.

It is to be noted that the foregoing is only preferred embodiments of the present disclosure and technical principles used. Those skilled in the art will appreciate that the present disclosure is not limited to specific embodiments discussed herein, and may perform various obvious changes, rearrangements and substitutions without departing from the scope of the present disclosure. Therefore, although the present disclosure has been described in detail with reference to the above embodiments, the present disclosure is not limited to the above embodiments, and may include more other equivalent embodiments without departing from the conception of the present disclosure, and the scope of the present disclosure is determined by the scope of the appended claims.

1. An electronic device, comprising a display screen, a host, an image collection device and a light source, wherein the image collection device is disposed in the host, the light source and a light-transmitting area are disposed on the host, the light-transmitting area is overlapped with a projection of a collection range, on the host, of the image collection device, the image collection device is configured to collect an image of an eye of a user using the electronic device through the light-transmitting area, and the image of the eye comprises a facula formed by the light source.

2. The electronic device as claimed in claim 1, wherein a number of the light source is at least two, two sides of the image collection device are provided with at least one light source, and a light-emitting center of the light source and a focus of a lens of the image collection device are disposed on a same straight line.

3. The electronic device as claimed in claim 1, wherein the electronic device comprises a transparent cover plate or a light filter, wherein the transparent cover plate or the light filter is disposed on the light-transmitting area.

4. The electronic device as claimed in claim 1, wherein the image collection device and the host are fixedly mounted at a set angle.

5. The electronic device as claimed in claim 4, wherein the image collection device is disposed towards a plane where a keyboard area on the host is located, and the image collection device directly collects the image of the eye through the light-transmitting area.

6. The electronic device as claimed in claim 1, wherein the electronic device comprises a reflection apparatus, wherein the reflection apparatus is disposed in the host, the image collection device faces the reflection apparatus, and the reflection apparatus is disposed to reflect light rays reflected by the eye of the user.

7. The electronic device as claimed in claim 6, wherein the reflection apparatus comprises one or more of the following:
a mirror face, a prism and a dichroic mirror.

8. The electronic device as claimed in claim 1, wherein the image collection device is movably mounted in the host.

9. The electronic device as claimed in claim 8, further comprising:
a motor, which is disposed in the host, wherein the motor is connected with the image collection device, and the motor is disposed to adjust the collection range of the image collection device.

10. The electronic device as claimed in claim 8, further comprising:
a device angle measuring apparatus, which is connected with the image collection device,
wherein the device angle measuring apparatus is disposed to collect a device angle parameter of the image collection device, and the device angle measuring apparatus is further disposed to transmit the device angle parameter to a processor, so that the processor carries out calibration point correction based on the device angle parameter.

11. The electronic device as claimed in claim 9, wherein an elevation angle of the image collection device is determined based on one or more of the following:
head location of the user; and an adjusting parameter of the display screen, and the adjusting parameter is determined based on a current screen angle parameter of the display screen.

12. The electronic device as claimed in claim 1, wherein the electronic device comprises a second rotating shaft and a screen angle measuring apparatus, one end of the display screen is connected with one end of the host through the second rotating shaft, the screen angle measuring apparatus is disposed in the second rotating shaft, the screen angle measuring apparatus is disposed to measure a screen angle parameter of the display screen and transmit the screen angle parameter to a processor, so that the processor carries out calibration point correction based on the screen angle parameter.

13. The electronic device as claimed in claim 2, wherein the electronic device comprises a second rotating shaft and a screen angle measuring apparatus, one end of the display screen is connected with one end of the host through the second rotating shaft, the screen angle measuring apparatus is disposed in the second rotating shaft, the screen angle measuring apparatus is disposed to measure a screen angle parameter of the display screen and transmit the screen angle parameter to a processor, so that the processor carries out calibration point correction based on the screen angle parameter.

14. The electronic device as claimed in claim 3, wherein the electronic device comprises a second rotating shaft and a screen angle measuring apparatus, one end of the display screen is connected with one end of the host through the second rotating shaft, the screen angle measuring apparatus is disposed in the second rotating shaft, the screen angle measuring apparatus is disposed to measure a screen angle parameter of the display screen and transmit the screen angle parameter to a processor, so that the processor carries out calibration point correction based on the screen angle parameter.

15. The electronic device as claimed in claim 4, wherein the electronic device comprises a second rotating shaft and a screen angle measuring apparatus, one end of the display screen is connected with one end of the host through the second rotating shaft, the screen angle measuring apparatus is disposed in the second rotating shaft, the screen angle measuring apparatus is disposed to measure a screen angle parameter of the display screen and transmit the screen angle parameter to a processor, so that the processor carries out calibration point correction based on the screen angle parameter.

16. The electronic device as claimed in claim 5, wherein the electronic device comprises a second rotating shaft and a screen angle measuring apparatus, one end of the display screen is connected with one end of the host through the second rotating shaft, the screen angle measuring apparatus is disposed in the second rotating shaft, the screen angle measuring apparatus is disposed to measure a screen angle parameter of the display screen and transmit the screen angle parameter to a processor, so that the processor carries out calibration point correction based on the screen angle parameter.

17. The electronic device as claimed in claim 6, wherein the electronic device comprises a second rotating shaft and a screen angle measuring apparatus, one end of the display screen is connected with one end of the host through the second rotating shaft, the screen angle measuring apparatus is disposed in the second rotating shaft, the screen angle measuring apparatus is disposed to measure a screen angle parameter of the display screen and transmit the screen angle parameter to a processor, so that the processor carries out calibration point correction based on the screen angle parameter.

18. The electronic device as claimed in claim 7, wherein the electronic device comprises a second rotating shaft and a screen angle measuring apparatus, one end of the display screen is connected with one end of the host through the second rotating shaft, the screen angle measuring apparatus is disposed in the second rotating shaft, the screen angle measuring apparatus is disposed to measure a screen angle parameter of the display screen and transmit the screen angle parameter to a processor, so that the processor carries out calibration point correction based on the screen angle parameter.

19. The electronic device as claimed in claim 8, wherein the electronic device comprises a second rotating shaft and a screen angle measuring apparatus, one end of the display screen is connected with one end of the host through the second rotating shaft, the screen angle measuring apparatus is disposed in the second rotating shaft, the screen angle measuring apparatus is disposed to measure a screen angle parameter of the display screen and transmit the screen angle parameter to a processor, so that the processor carries out calibration point correction based on the screen angle parameter.

20. The electronic device as claimed in claim, wherein the electronic device comprises a second rotating shaft and a screen angle measuring apparatus, one end of the display screen is connected with one end of the host through the second rotating shaft, the screen angle measuring apparatus is disposed in the second rotating shaft, the screen angle measuring apparatus is disposed to measure a screen angle parameter of the display screen and transmit the screen angle parameter to a processor, so that the processor carries out calibration point correction based on the screen angle parameter.
